(19) United States
(12) Patent Application Publication
(10) Pub. No.: US 2011/0279370 A1
(43) Pub. Date: Nov. 17, 2011

(54) DISPLAY DEVICE HAVING STYLUS PEN WITH JOYSTICK FUNCTIONS

(75) Inventors: YI-CHING WANG, HSINCHU CITY (TW); TZU-MING WANG, HSINCHU CITY (TW)

(73) Assignee: E INK HOLDINGS INC., HSINCHU CITY (TW)

(21) Appl. No.: 12/848,454

(22) Filed: Aug. 2, 2010

(30) Foreign Application Priority Data
May 12, 2010 (TW) 99115198

(51) Int. Cl. G06F 3/033

(52) U.S. Cl. 345/161

(57) ABSTRACT

The configurations of a display device are provided in the present invention. The proposed display device includes a screen and a joystick control device having a stylus pen.

### FIELD OF THE INVENTION

The present invention relates to a display device comprising a stylus pen with joystick functions. More particularly, it relates to a display device having a stylus pen with joystick functions and being one selected from a group consisting of an electronic book, an electrophoresis display and an astable state display.

### BACKGROUND OF THE INVENTION

Following the increase of the electronic paper display functions, the currently employed key-press and guide way input structures are not enough to fulfill all of the requirements generally speaking, and there are many display devices, each of which has a screen with touch functions, require a separate stylus pen provided such that the electronic paper displays and their related products could support text input, keyboard, handwriting recognition functions and other functions for raising the productivity. For example, a stylus pen having a high accuracy could allow users to input an Asian text with a complex structure and to select an icon getting smaller and smaller on an operational interface. When a joystick device is employed as one of the input devices, it could be used for either controlling a movement of a cursor on a display screen, or operating in cooperation with at least one of a plurality of control buttons so as to input a datum. If the stylus pen and the joystick could be combined as one, then this will bring even more convenience.

But an existing joystick control device can not be disassembled (to be a stylus pen) and does not have a stylus function and an existing electronic display device is mostly equipped with a keyboard or a touch screen and can not be used with a joystick control device in common, thus improvements are urgently needed.

Keeping the drawbacks of the prior arts in mind, and employing experiments and research full-heartily and persistently, the applicant finally conceived a display device having a stylus pen with joystick functions.

### SUMMARY OF THE INVENTION

It is therefore an object of the present invention to provide a joystick control device having joystick functions and stylus pen functions, comprising a stylus pen and a main body, using as a joystick when the stylus pen connects the main body, using as a stylus pen when the stylus pen is separate from the main body, configured in one being selected from a group consisting of an electronic book, an electrophoresis display and an astable state display, possessing a multi-advantage and being quite convenient.

According to the first aspect of the present invention, a display device comprises a display screen, and a joystick control device having a joystick function and a stylus pen function, wherein the display device is one selected from a group consisting of an electronic book, an electrophoresis display and an astable state display.

According to the second aspect of the present invention, a display device comprises a display screen, and a joystick control device having a stylus pen function.

According to the third aspect of the present invention, a display device comprises a joystick control device having a stylus pen.

The present invention may best be understood through the following descriptions with reference to the accompanying drawings, in which:

### BRIEF DESCRIPTION OF THE DRAWINGS

FIG. 1 is a schematic diagram of a display device having a stylus pen with joystick functions when the stylus pen connects the main body according to the preferred embodiment of the present invention; and

FIG. 2 is a schematic diagram of a display device having a stylus pen with joystick functions when the stylus pen is separate from the main body according to the preferred embodiment of the present invention.

### DETAILED DESCRIPTION OF THE PREFERRED EMBODIMENT

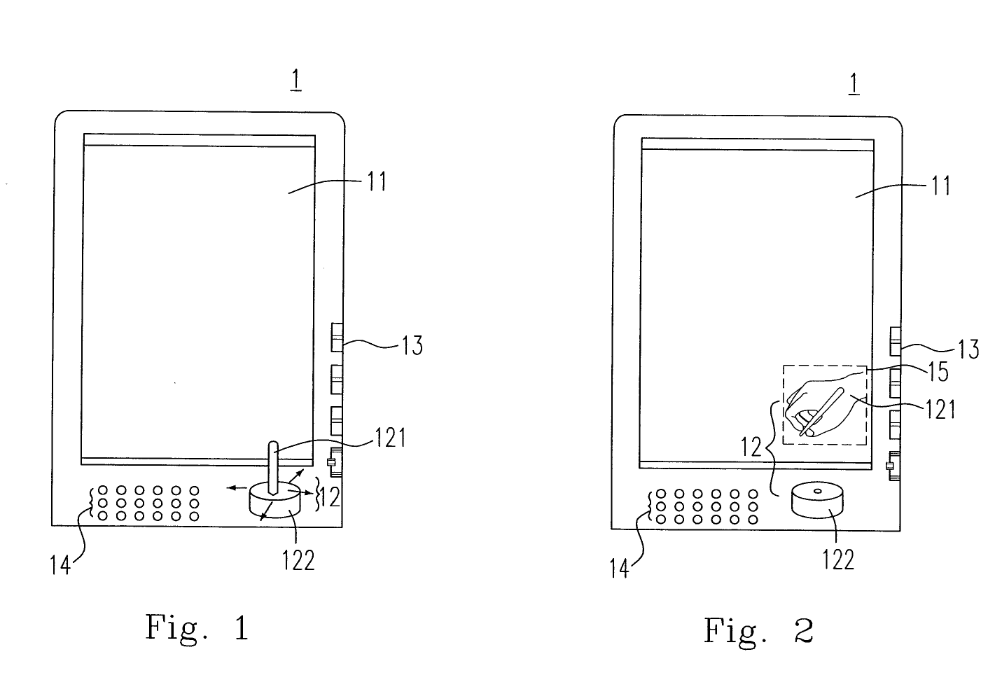

FIG. 1 is a schematic diagram of a display device having a stylus pen with joystick functions when the stylus pen connects the main body according to the preferred embodiment of the present invention. The display device 1 having a stylus pen with joystick functions comprises a display screen 11, and a joystick control device 12 (including a stylus pen 121 and a main body 122), a main frame 13 and a plurality of controlling buttons 14. FIG. 2 is a schematic diagram of the display device having the stylus pen with joystick functions when the stylus pen is separate from the main body according to the preferred embodiment of the present invention. Except for the aforementioned elements as shown in FIG. 1, there is a touch panel 15 further included in FIG. 2.

The joystick control device 12 has a joystick (12) function and a stylus pen (121) function, wherein the display device 1 is one selected from a group consisting of an electronic book, an electrophoresis display and an astable state display.

As above-mentioned, the joystick control device 12 includes the main body 122 and the stylus pen 121, and the stylus pen 121 is combined with the touch panel 15 to select a position on the display screen 11 so as to input a datum when the stylus pen 121 is separate from the main body 122.

The joystick control device 12 is used as a joystick (12) being in one of the two states controlling a movement of a cursor on the display screen 11 and operating in cooperation with at least one of the plurality of control buttons 14 so as to input a datum when the stylus pen 121 connects the main body 122.

The main body 122 is one of a navi-key and an arrow key, and can be embedded with the stylus pen 121.

According to the aforementioned descriptions, the present invention provides a joystick control device having joystick functions and stylus pen functions, comprising a stylus pen and a main body, using as a joystick when the stylus pen connects the main body, using as a stylus pen when the stylus pen is separate from the main body, configured in one being selected from a group consisting of an electronic book, an electrophoresis display and an astable state display, possessing a multi-advantage and being quite convenient so as to possess the non-obviousness and the novelty.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present invention which is defined by the appended claims.

What is claimed is:

1. A display device, comprising:
a display screen; and
a joystick control device having a joystick function and a stylus pen function,
wherein the display device is one selected from a group consisting of an electronic book, an electrophoresis display and an astable state display.

2. A device according to claim 1 further comprising a mainframe, a touch panel and a plurality of control buttons.

3. A device according to claim 2, wherein the joystick control device comprises a main body and a stylus pen, and the stylus pen is combined with the touch panel to select a position on the display screen so as to input a datum when the stylus pen is separate from the main body.

4. A device according to claim 3, wherein the joystick control device is used as a joystick being in one of the two states controlling a movement of a cursor on the display screen and operating in cooperation with at least one of the plurality of control buttons so as to input a datum when the stylus pen connects the main body.

5. A device according to claim 3, wherein the main body is one of a navi-key and an arrow key.

6. A display device, comprising:
a display screen; and
a joystick control device having a stylus pen function.

7. A device according to claim 6 further comprising a touch panel, wherein the joystick control device comprises a stylus pen and a main body, and the stylus pen is combined with the touch panel to select on the display screen so as to input a datum when the stylus pen is separate from the main body.

8. A device according to claim 7 further comprising a plurality of control buttons, wherein the joystick control device is used as a joystick being in one of the two states controlling a movement of a cursor on the display screen and operating in cooperation with at least one of the plurality of control buttons so as to input a datum when the stylus pen connects the main body.

9. A device according to claim 7 further comprising a mainframe.

10. A display device, comprising:
a joystick control device having a stylus pen.

11. A device according to claim 10 further comprising a display screen, a touch panel and a mainframe, wherein the stylus pen is combined with the touch panel to select on the display screen so as to input a datum.

12. A device according to claim 10 further comprising a plurality of control buttons, wherein the joystick control device further comprises a main body, and has a joystick function being in one of the two states controlling a movement of a cursor on the display screen and operating in cooperation with at least one of the plurality of control buttons so as to input a datum when the stylus pen connects the main body.
